(19) United States
(12) Patent Application Publication
(10) Pub. No.: US 2002/0042793 A1
(43) Pub. Date: Apr. 11, 2002

(54) Method of order-ranking document clusters using entropy data and bayesian self-organizing feature maps

(76) Inventor: Jun-Hyeog Choi, Incheon-si (KR)

Correspondence Address: DANN DORFMAN HERRELL & SKILLMAN, SUITE 720, 1601 MARKET STREET, PHILADELPHIA, PA, 19103-2307, US

(21) Appl. No.: 09/928,150

(22) Filed: Aug. 10, 2001

(30) Foreign Application Priority Data
Aug. 23, 2000 (KR) 48977/2000

(51) Int. Cl. G06F 7/00

(52) U.S. Cl. 707/6; 707/3

(57) ABSTRACT

A method of order-ranking document clusters using entropy data and Bayesian self-organizing feature maps(SOM) is provided in which an accuracy of information retrieval is improved by adopting Bayesian SOM for performing a real-time document clustering for relevant documents in accordance with a degree of semantic similarity between entropy data extracted using entropy value and user profiles and query words given by a user, wherein the Bayesian SOM is a combination of Bayesian statistical technique and Kohonen network that is a type of an unsupervised learning.

### BACKGROUND OF THE INVENTION

1. Field of the Invention

The present invention relates to a method of order-ranking document clusters using entropy data and Bayesian self-organizing feature maps(SOM), in which an accuracy of information retrieval is improved by adopting Bayesian SOM for performing a real-time document clustering for relevant documents in accordance with a degree of semantic similarity between entropy data extracted using entropy value and user profiles and query words given by a user, wherein the Bayesian SOM is a combination of Bayesian statistical technique and Kohonen network that is a type of an unsupervised learning.

The present invention further relates to a method of order-ranking document clusters using entropy data and Bayesian SOM, in which savings of search time and improved efficiency of information retrieval are obtained by searching only a document cluster related to the keyword of information request from a user, rather than searching all documents in their entirety.

The present invention even further relates to a method of order-ranking document clusters using entropy data and Bayesian SOM, in which a real-time document cluster algorithm utilizing self-organizing function from Bayesian SOM is provided from entropy data for query words given by a user and index word of each of the documents expressed in an existing vector space model, so as to perform a document clustering in accordance with semantic information to the documents listed as a result of search in response to a given query in Korean language web information retrieval system.

The present invention still further relates to a method of order-ranking document clusters using entropy data and Bayesian SOM, in which, if the number of documents to be clustered is less than a predetermined number(30, for example), which may cause difficulty in obtaining statistical characteristics, the number of documents is then increased up to a predetermined number(50, for example) using a bootstrap algorithm so as to seek document clustering with an accuracy, a degree of similarity for thus-generated cluster is obtained by using Kohonen centroid value of each of the document cluster groups so as to rank higher order the document which has the highest semantic similarity to the user query word, and the order of cluster is re-ranked in accordance with the value of degree of similarity, so as to thereby improve accuracy of search in information retrieval system.

2. Description of the Related Art

Recently, there has been a large amount of information in the form of web documents throughout the Internet due to the wide spread use of computers and development of the Internet. Such a web document is distributed throughout a variety of sites, and the information contained in the web document changes dynamically. Therefore, it is not easy to retrieve the desired information from among those distributed throughout the web site.

In general, an information retrieval system collects needed information, performs analysis on the collected information, processes the information into a searchable form, and attempts to match user queries to locate information available to the system. One of the important functions for such an information retrieval system, in addition to performing searches for documents in response to user queries, is to order-rank searched text according to the document relevance judgment, to thereby minimize the time period required for obtaining desired information.

A “concept model” from among a variety of types of information retrieval models can be classified into an exact match method and an inexact match method in accordance with search techniques. The exact match method includes a text pattern search and Boolean model, while the inexact match method includes a probability model, vector space model and clustering model. Two or more models can be mixed, since such classified models are not mutually exclusive.

A study on the content search from among a plurality of information retrieval models, has been increased. The study adopts a full text scanning technique, an inverted index file technique, a signature file technique and a clustering technique.

FIG. 1 illustrates a common web information retrieval system, wherein a document identifier is allocated for each web document collected by a web robot. Subsequently, indexable words are extracted by performing syntax analysis through a morphological property analysis for all documents collected.

Each indexable word of extracted documents is as signed with weights of terms based on the number of occurrences of the inverted document, and an inverted index file is constructed based on the given weights of terms.

In most commercial information retrieval systems designed based on a Boolean model, each document is expressed in an index word list made up of subject words. An information request from a user using the index word list is expressed in a query for performing a search for the presence of the subject word representing the content of the document.

In a Boolean model, most systems use a common criteria for selecting an evaluation function for the documents satisfying a user query. That is, most of the statements of the query language set out the search criteria in logical or “Boolean” expressions. An evaluation as to whether the corresponding document is an appropriate document or not is performed in accordance with whether the index word included in a query in a Boolean expression exists in the document.

Typically, a Boolean model uses an inverted index file. In an information retrieval model using an inverted index file, an inverted index file list including subject words and list identifiers for documents is made with respect to all the documents collected by a web robot, and an information search is performed for the generated inverted file list using files aligned in alphabetical order according to the main word. Thus, a search result is obtained according to the presence of the query word in the relevant files.

A Boolean model which uses an inverted index file has difficulty in expressing and reflecting with precision a user request for information, and the number of documents as a result of the search is determined according to the number of relevant documents including the query word. In such a system, weights indicating level of importance for index words for user query and documents have not been taken into account. Moreover, search results can be obtained in the order of inverted index files pre-designed by a system designer regardless of the intention of a user, and semantic information for queries given by a user may not be sufficiently reflected.

Therefore, in a Boolean model, the subject document to be searched can be adjusted only by a restricted method provided by a system.

Here, most of the search results may not satisfy the intention of a user query, and thus show a search result in the order of the document regardless of the intention of user query. Such a Boolean model may provide a robust on-line search function to expert users such as a librarian or those familiar to system usage.

However, a Boolean model is not satisfactory for most of the users who do not frequently visit a system.

In general, most common users are familiar with terms in a data aggregate to be searched, but they are not skillful to use composite query words required by a Boolean system.

As described above, it is required that an information request from a user who uses an information search engine on the web has to be order-ranked in the order of relevance correctly reflecting a users intention after a search for the relevant web documents has been completed. However, most of the web information search engines have disadvantages in that documents as a result of the search which lack the relevance with the user's needs are ranked in higher order.

Therefore, there is a need for a web search engine which can reflect a user's request for information with accuracy.

### SUMMARY OF THE INVENTION

Therefore, it is an object of the present invention to provide a method of order-ranking document clusters using entropy data and Bayesian self-organizing feature maps(SOM), in which an accuracy of information retrieval is improved by adopting Bayesian SOM for performing real-time document clustering for related documents in accordance with a degree of similarity of sense between entropy data extracted using entropy value and user profiles and query words given by a user, wherein the Bayesian SOM is a combination of Bayesian statistical technique and Kohonen networks, kind of unsupervised learning.

It is another object of the present invention to provide a method of order-ranking document clusters using entropy data and Bayesian SOM, in which savings of searching time and improved efficiency of information retrieval are obtained by searching only a document cluster related to the subject, rather than searching all documents subject to information retrieval.

It is still another object of the present invention to provide a method of order-ranking document clusters using entropy data and Bayesian SOM, in which a real-time document cluster algorithm utilizing Bayesian SOM function is provided from entropy data for user query words and index word of each of the documents expressed in an existing vector space model, so as to perform document clustering in accordance with semantic information for text retrieved in response to a given query in a Korean language web information retrieval system.

It is still a further object of the present invention to provide a method of order-ranking document clusters using entropy data and Bayesian SOM, in which, if the number of documents to be clustered is less than a predetermined number, which may cause difficulty in obtaining statistical characteristics, the number of documents is then increased up to a predetermined number using a bootstrap algorithm so as to seek document clustering with an accuracy, a degree of similarity for thus-generated cluster is obtained by using Kohonen centroid value for each of the document cluster groups so as to rank in higher order the document which has the highest similarity to the query word given by a user, and the order of cluster is adjusted in accordance with the value of degree of similarity, so as to improve accuracy of the search in an information retrieval system.

To accomplish the above objects of the present invention, there is provided a method of order-ranking document clusters using entropy data and Bayesian SOM, including a first step of recording a query word by a user; a second step of designing a user profile made up of keywords used for the most recent search and frequencies of the keywords, so as to reflect a user's preference; a third step of calculating entropy value between keywords of each web document and the query word and user profile; a fourth step of judging whether data for learning Kohonen neural network which is a type of unsupervised neural network model, is sufficient or not; a fifth step of ensuring the number of documents using a bootstrap algorithm, a type of statistical technique, if it is determined in the fourth step that the data for learning Kohonen neural network is not sufficient; a sixth step of determining prior information to be used as an initial value for each parameter of network through Bayesian learning, and determining an initial connection weight value of Bayesian SOM neural network model where the Kohonen neural network and Bayesian learning are coupled one another; and a seventh step of performing a real-time document clustering for relevant documents using the entropy value calculated in the third step and Bayesian SOM neural network model.

In a preferred embodiment of the present invention, the seventh step of performing real-time document clustering includes the step of determining a clustering variable by calculating entropy value between keywords of each web document and the query word and the user profile.

In a preferred embodiment of the present invention, the prior information determined in the sixth step takes the form of probability distribution, and the network parameter has a Gaussian distribution.

Additional features and advantages of the present invention will be made apparent from the following detailed description of a preferred embodiment, which proceeds with reference to the accompanying drawings.

### BRIEF DESCRIPTION OF THE DRAWINGS

FIG. 1 illustrates a conventional web information retrieval system;

FIG. 2 is a flow chart illustrating a method of order-ranking document clusters using entropy data and Bayesian SOM;

FIG. 3 illustrates a web information retrieval system according to the present invention;

FIG. 4 illustrates an overall configuration of Korean language web document order-ranking system using entropy data and Bayesian SOM according to an embodiment of the present invention;

FIGS. 5A-5D illustrate concepts of hierarchical clustering for a statistical similarity between document clustering and query words according to the present invention; wherein

FIG. 5A illustrates the concept of a single linkage method;

FIG. 5B illustrates the concept of a complete linkage method;

FIG. 5C illustrates the concept of a centroid linkage method; and

FIG. 5D illustrates the concept of an average linkage method.

FIG. 6 illustrates an algorithm of hierarchical clustering using a statistical similarity according to an embodiment of the present invention;

FIG. 7 illustrates a configuration of competitive learning mechanism according to the present invention;

FIG. 8 illustrates a configuration of Kohonen network according to the present invention;

FIGS. 9A-9D illustrate a concept related to Bayesian SOM and K-means of bootstrap according to the present invention; wherein

FIG. 9A illustrates the concept for each of initial documents;

FIG. 9B illustrates the concept of forming initial document cluster;

FIG. 9C illustrates the distance of each document cluster from a centroid; and

FIG. 9d illustrates the concept of finally formed document cluster.

FIG. 10 is a graphical representation illustrating relations between number of learning data and connecting weights according to the present invention; and

FIG. 11 illustrates a document clustering algorithm adopting Bayesian SOM according to the present invention.

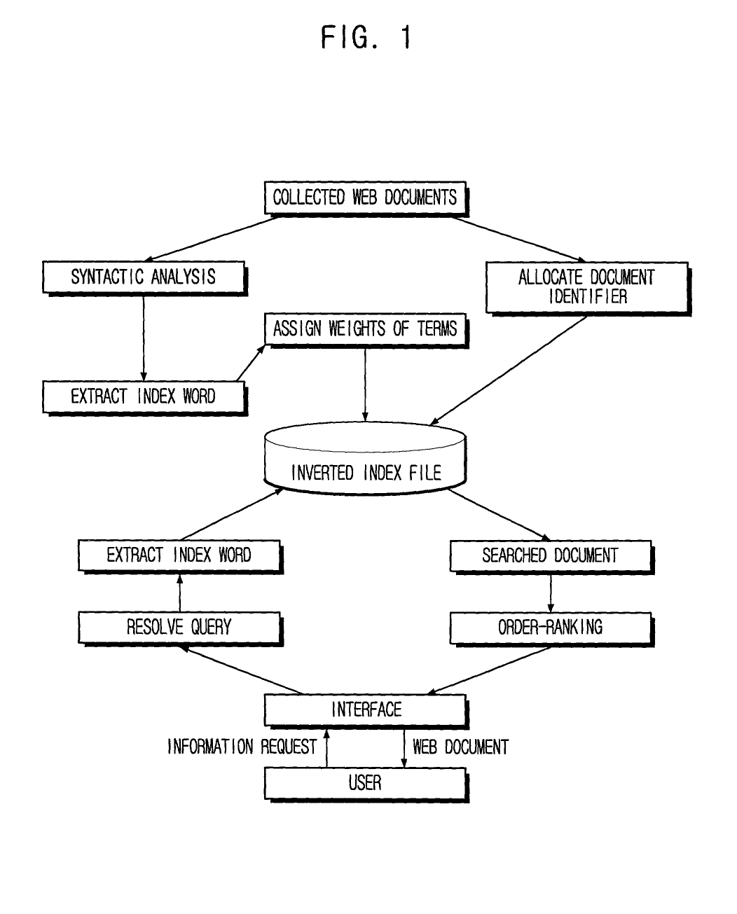

### DETAILED DESCRIPTION OF THE PREFERRED EMBODIMENTS

Now, preferred embodiments of the present invention will be explained in more detail with reference to the attached drawings.

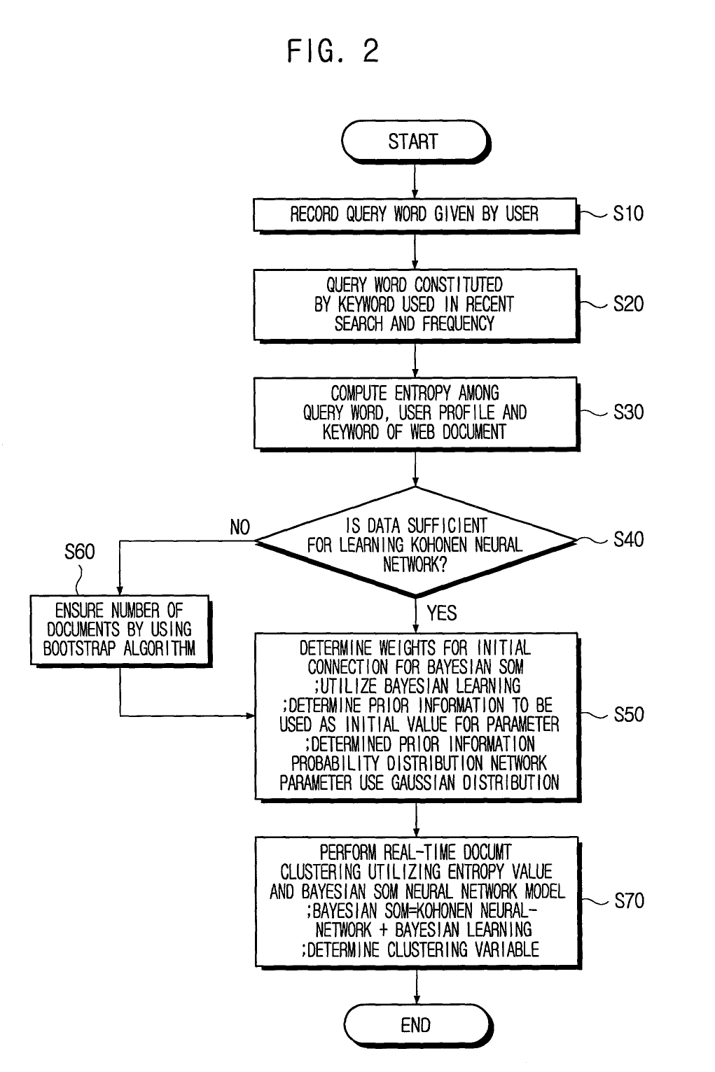

Referring to FIG. 2, a method of order-ranking document clusters using entropy data and Bayesian SOM according to the present invention, includes the steps of recording query words given by users for search(S10), designing user files made up of the keywords used for the most recent search and their frequencies so as to reflect user preference(S20), calculating entropy among query words given by users, user profiles and keywords of each web document(S30), judging whether data for learning Kohonen neural network, which is a type of unsupervised neural network model, is sufficient or not(S40); a fifth step of ensuring number of documents using a bootstrap algorithm, a type of statistical technique, if it is determined in the fourth step that the data is not sufficient(S60); a sixth step of determining a prior information to be used as an initial value for each parameter of network through Bayesian learning, and determining an initial connection weight value of Bayesian SOM neural network model where the Kohonen neural network and Bayesian learning are coupled(S50); and a seventh step of performing a real-time document clustering for relevant documents using the entropy value calculated in the third step and Bayesian SOM neural network model(S70).

The above-mentioned step S70 further includes the step of calculating entropy value for query words given by a user and user profiles with respect to keywords for each of the web documents, and determining clustering variables.

In the above-mentioned step S50, the prior information takes the form of probability distribution, and the parameter of network takes the form of Gaussian distribution.

Thus-configured method of order-ranking document clusters according to the present invention, is performed as follows.

There are several techniques related to the method of order-ranking document clusters using entropy data and Bayesian SOM.

With a document ranking method, a document search system with a high user-oriented property can be obtained. In such a system, a user inputs simple query words such as sentences or phrases rather than Boolean expressions, in order to search document list which is order-ranked by the relevance for use queries. A vector space model is one of the representatives for such system.

In a vector space model, each of the documents and user queries are expressed in N-dimensional vector space model, wherein N indicates the number of keywords existing in each of the documents. In this model, function for matching user query and documents is evaluated by a semantic distance determined by a similarity between the query given by a user and documents. In Salton's SMART system, similarity between the user query and documents is calculated by a cosine angle between vectors. In this case, the search result is delivered to a user in order of descending similarity.

The complexity of calculating similarity for each of the documents, may cause delay in search time. To prevent such problems, there has been proposed a method of searching only the documents where the keywords satisfying the user query exist, by making reference to an inverted index file. Another method has been proposed to prevent the problems, in which a search is performed only for the cluster which has a highest relevance to the user query in terms of semantic distance, by pre-clustering all of the documents in accordance with the semantic similarity and calculating similarity for the pre-clustered documents. By performing a search only for the document cluster related to the keywords, rather than searching the related documents in their entirety, the length of time required for search can be decreased while improving efficiency of searching.

The document clustering technique forms a document cluster utilizing an index word presented in the document or a mechanically extracted keyword, as an identifier element for the document content. Thus-formed document cluster has a cluster profile representing the clusters, and a selection is made to the cluster which has the highest relevance to the user query, by comparing the user query and profiles of each of the clusters during execution of the searches.

Applying document clustering techniques to a web information search is based on a hypothesis that the documents with high relevance are all suitable for the same information request. In other words, documents with similar contents belonging to the same cluster have a high probability of relevance for the same query. Therefore, the entire document can be divided into several clusters by grouping the documents with similar contents into the same cluster by a document clustering technique.

There has been increasingly widespread interest in a document clustering system. There are studies on a sequential cluster search and a document cluster search as the representative studies on the document clustering system. In general, a cluster-based searching system has superiority in terms of physical property of using a disc and efficiency of search. However, most of the clustering algorithm has shortcomings in that it requires an increased length of time for forming clusters, with a low efficiency of search and low performance in terms of length of searching time. Moreover, attributes of the formed cluster are not so preferable. In practice, it is difficult to effectively use such a clustering algorithm for a large collection of documents. Therefore, most of the systems are used experimentally for several hundreds of documents. That is to say, study on a document clustering system is directed toward a tendency where the document clustering algorithm is applied to documents satisfying user queries rather than to the entire document to be searched, so as to eliminate the problem of clustering time. The documents to be searched are clustered in accordance with the sense of user queries in order to satisfy the cluster property.

In an existing study on a Korean language information retrieval system aimed to improve accuracy of search, most of the studies are concentrated onto the processing of nouns and compound nouns for extracting the correct index word.

One such studies adopts, rather than an information retrieval system utilizing keywords representing the document, a concept of “key-fact” that includes a noun phrase and simple sentences in addition to keywords, considering ambiguity of words caused by homonyms and derivatives, characteristics of the Korean language. Here, the key-facts indicate the “fact” that a user intends to search within a document. However, a large volume of dictionary containing a large collections of nouns and adjectives in addition to noun dictionary, is required for extracting key-fact, which is laborious and time consuming.

In another study, an order-ranking algorithm based on a thesaurus is utilized in order to show the degree of satisfaction for user queries in a Boolean search system. A thesaurus is a kind of dictionary with vocabulary classification in which words are expressed in conceptual relation according to word sense, and a specific relation between concepts, for example, hierarchical relation, entire-part, and relevance, is indicated. A thesaurus is employed for selection of an appropriate index word and control of the index word during indexing work, and for selection of an appropriate search language while executing an information search.

Therefore, an information search with a thesaurus obtains an improved efficiency of search through the expansion of a query word, in addition to the control of index words.

Since the index word is selected from a thesaurus in the thesaurus-based information retrieval system, documents having the same contents are retrieved by the same index word regardless of the specific words of documents, thus increasing reproducibility of the information retrieval system by an association between index words. However, since the vocabulary hierarchy of thesaurus type is built according to the sense of the word, usage of the word in a thesaurus type vocabulary hierarchy can be different from that of the word found in an actual corpus. Therefore, if the similarity found in the vocabulary hierarchy is used for an information search as it is, reproducibility is increased, thereby deteriorating accuracy of a query search.

In an embodiment of a thesaurus-based information retrieval system, a two-stage document ranking model technique utilizing mutual information is proposed to obtain an improved accuracy of search in a natural language information retrieval system. In the proposed technique, the secondary document ranking is peformed by the value of mutual information volume between search words of a user query and keywords of each of the documents.

When only the value of mutual information volume is used as an input to the Bayesian SOM proposed in the present invention, connection weights for the relevant neurons can be easily and promptly obtained. However, there also exists the problem in that the weights may be converged into a local convergence value.

To the contrary, if the entropy value obtained from the mutual information value is used as an input to the Bayesian SOM, a parameter value for the network can be estimated with stability, although the speed of converging the connection weights of the relevant neurons to the true value is little bit low. Accordingly, the mutual information volume and entropy data can be adjusted suitably in accordance with the change of value of information volume. In document clustering based on the semantic similarity between documents according to the present invention, the computation for similarity between documents is performed utilizing measurement of entropy with stability, while overcoming the problem of the long period of time taken for document clustering by the Bayesian SOM.

Typical types of search engines do not understand query phrases of natural language format, and thus may not correctly process the contents of documents which require knowledge on the semantics of language and subject of the document. Furthermore, most of the search engines have drawbacks in that they are not provided with inference function, and thus may not utilize prior information for users. To overcome such problems, a study of the intelligent information retrieval system adopting relevance feedback system where mutual information volume is used, is in progress.

To give intelligence to the search engine, an ability of utilizing systematized knowledge in addition to the ability of utilizing simple data or information, is required. Furthermore, an inference function is required for obtaining an understanding of natural language and for solving a problem. In other words, it is a must that an intelligent search engine is a knowledge-based system that utilizes a variety of knowledge databases and performs relevant inference from the knowledge built therein. The inference function can be explained in three phases, as follows.

(1) Association inference between information request and document utilizing index knowledge

(2) Appropriate inference utilizing knowledge of users

(3) Inference for new query words utilizing knowledge on subject

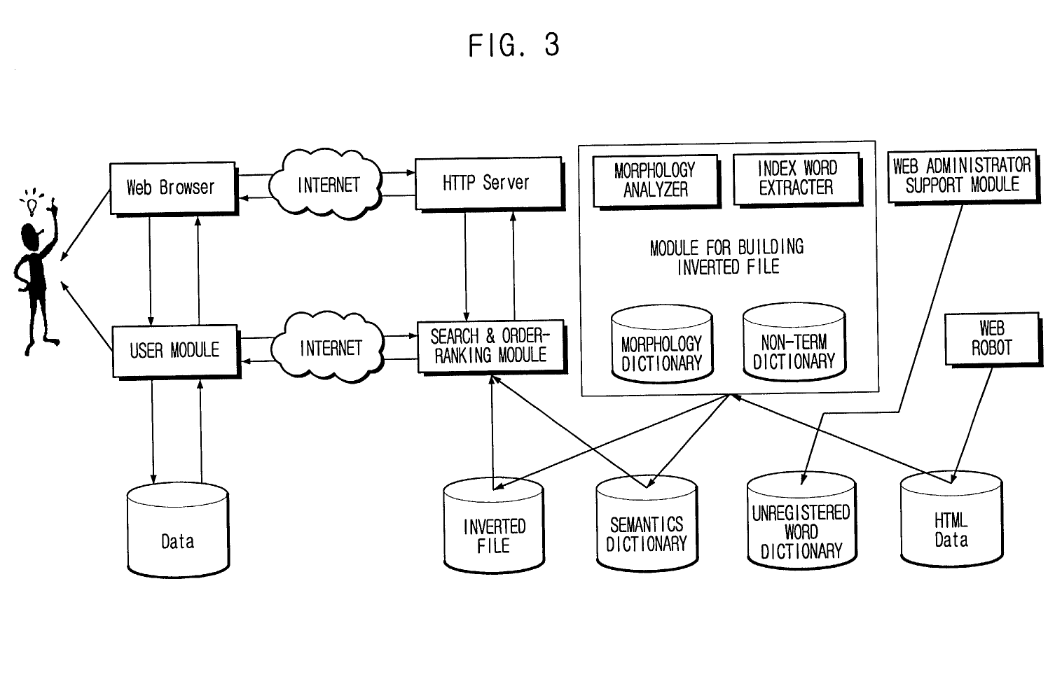

FIG. 3 illustrates an embodiment of an overall configuration of a Korean language web information retrieval system according to the present invention.

To make the Korean language web information retrieval system of the present invention intelligent, differently from an existing Korean language web information retrieval system, a mutual information volume, i.e., degree of association of words, is computed from corpus, and Bayesian SOM for performing real-time document clustering in accordance with semantic similarity for the documents having relevancy to a query word given by a user, is designed based on the mutual information volume. Then, an inference for association among documents is executed utilizing the Bayesian SOM.

To recognize the tendency of information requested by a user is very important. However, it is still difficult, in terms of technical aspect, to model and realize such a recognition for the tendency. To obtain recognition, an interface is required in which interests of users are indirectly inferred by analyzing user behavior or inputs, rather than the existing user query word input system. To effectively realize an information filtering system by learning user preferences, a technique of expressing user preferences for using information and updating the content of the user preferences according to learning of the user preference, a technique of effectively expressing web information, and a technique of performing information filtering according to learning, are required.

In an information retrieval system, it is significant to rank at a higher level the searched documents which have high relevancy to the user query without deteriorating the query search, selection and ratio of reproducibility, so as to thereby increase the degree of user satisfaction with respect to the system. The object and scope of the present invention to increase user satisfaction can be summarized as follows.

The present invention proposes a neural approach for document clustering for related documents having the same sense so as to search documents with efficiency. First, entropy value between keyword of each of the web documents, and query word given by a user and user profile is computed(S20 and S30 in FIG. 2). A real-time document clustering is performed utilizing the entropy value obtained in the previous step and Bayesian SOM neural network model where Kohonen neural network and Bayesian learning are combined(S70). Here, the Bayesian neural network model is of an unsupervised type designed in accordance with the present invention. If the volume of data for learning neural network is not sufficient to reflect correct statistical characteristics, document clustering is performed after ensuring the number of documents sufficient for stabilizing network employing bootstrap algorithm, one of statistical technique, to thereby improve generalization ability of neural network(S40 and S60). For example, the number of documents is set as fifty for experiment in the present invention.

To determine initial connection weights for Bayesian SOM of the present invention, Bayesian learning is employed, wherein prior information to be used as an initial value for each parameter of the network is determined through learning.

Here, the prior information has a format of probability distribution, and Gaussian distribution is employed for the network parameter(S50).

To determine the clustering variable which is a pre-requisite for document clustering, entropy value between keywords of each of the web documents and query word given by a user and user profile is computed.

Clustering individuals aims to obtain understandings of the overall structure by grouping individuals according to similarity and recognizing characteristics of each group. Clustering individuals can employ a variety of techniques such as an average clustering method, an approach utilizing distance of statistical similarity or dissimilarity, and the like.

In the present invention, characteristics of groups for clustering can be expressed in the number of relevant documents that a specific group includes to match the information request from user. Document clustering performed in a system where document ranking is obtained by computing entropy value between query word and user profiles for each of the documents, and grouping the documents by using the entropy value as a value for the clustering variable, results in further increased user satisfaction than a document clustering system where each of a large collections of documents is individually ranked.

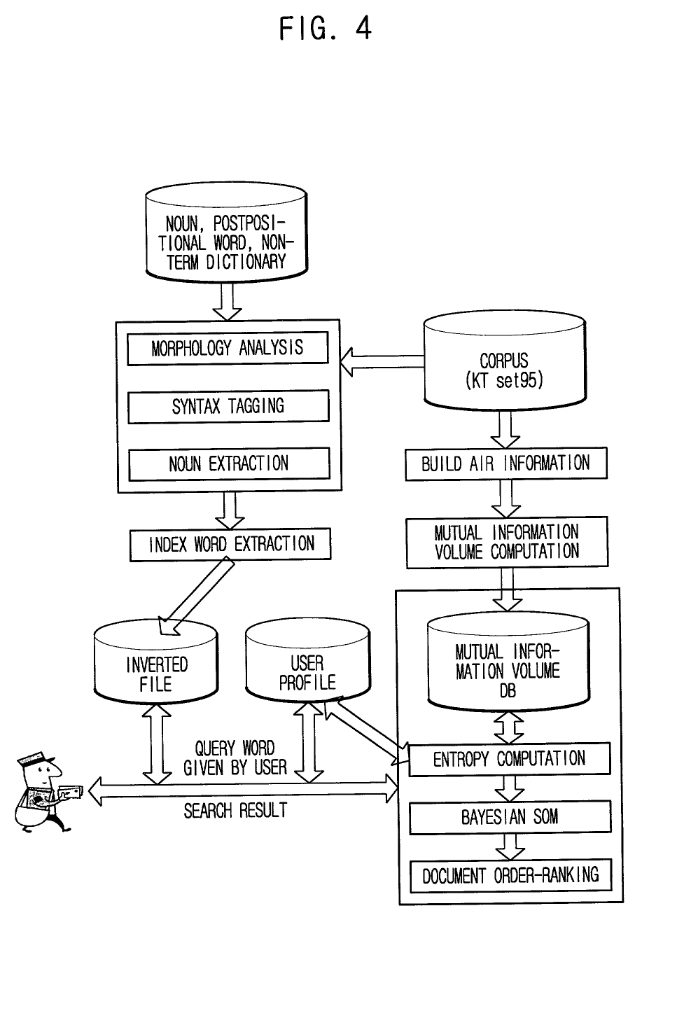

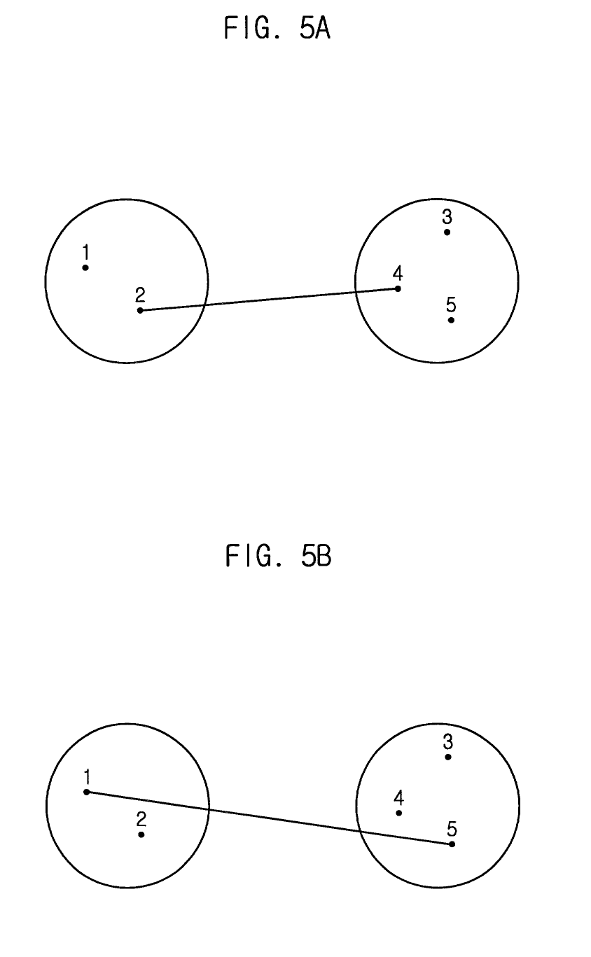

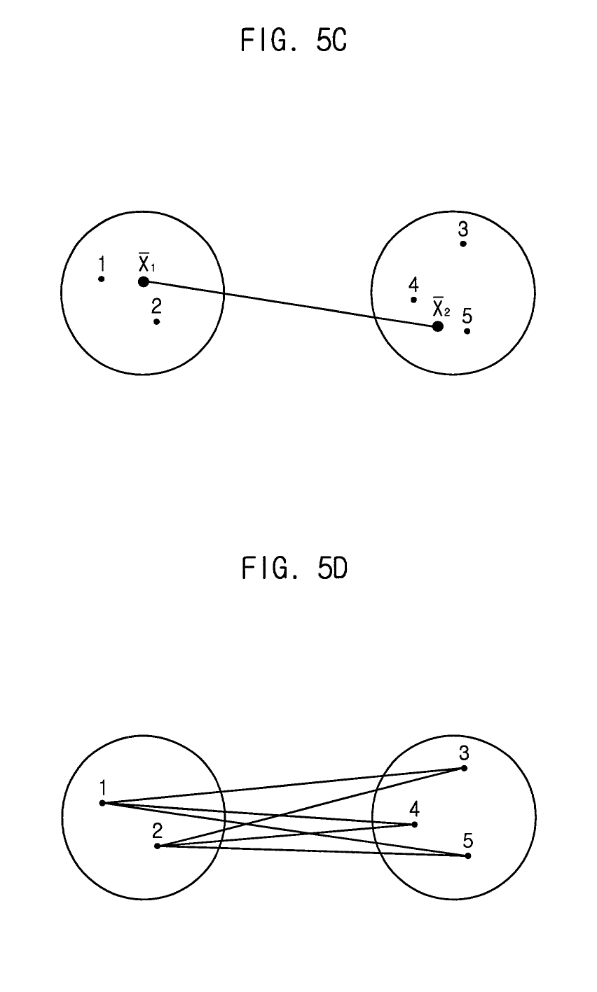

FIG. 4 illustrates an overall configuration of a Korean language web information retrieval system based on an order-ranking method utilizing entropy value and Bayesian SOM according to an embodiment of the present invention.

Referring to FIG. 4, if the number of documents as a result of a search according to a query word given by a user is lower than thirty, document clustering module by Bayesian SOM is emitted, and the documents to be searched are re-ranked only by an entropy value and document ranking module utilizing user profiles.

In the present invention, Bayesian SOM where Kohonen neural network and Bayesian learning are coupled is designed for performing real-time document clustering for query word given by a user and semantic information. Such a design results from an analysis on the merits and drawbacks of existing clustering algorithms. In addition, the present invention provides an algorithm employed for competitive learning for Bayesian SOM, and an approach for determining initial weights utilizing probability distribution of data for learning so as to determine each connection weights for neural network. Further, the present invention provides a method of combining a bootstrap algorithm with Bayesian SOM for the case where it is difficult to extract statistical characteristics, for instance, in the case where counts of data for learning is less than thirty.

Now, the method of order-ranking document clusters using entropy data and Bayesian self-organizing feature maps(SOM) according to the present invention will be explained with reference to the above-described technical matters.

In an information retrieval system using document cluster, only the document cluster related to the subject of information requested by user is searched rather than searching the document in its entirety, to thereby seek reduction of searching time and enhanced efficiency of search. In this respect, a study on a method of utilizing document clustering so as to obtain improved search results, is in progress.

In the present invention, document clustering by semantic information is performed for the documents listed as a result of search in Korean language web information retrieval system. For such a clustering, a real-time document clustering algorithm utilizing self-organizing function of Bayesian SOM is designed utilizing entropy data between query word given by a user and index words of each of the documents expressed in an existing vector space model.

A document clustering according to the present invention can be analyzed as follows.

Document clustering can be roughly divided into two types. One of the two types is for performing document clustering for a collection of documents in its entirety so as to obtain an improved accuracy of search result, and suggesting search result after checking whether the query word and cluster centroid match with each other. The other type is for performing post-clustering so as to suggest a more effective search result to users. The first type aimed for improving quality of search result, i.e., an accuracy of search result. However, such an approach is not so efficient as compared with a search system that employs a document ranking method.

Typically, an AHC(agglomerative hierarchical clustering) approach has been widely used. This algorithm, however, has shortcomings in that searching speed is significantly lowered if the number of documents to be processed is large. To overcome such drawbacks, counts of clusters can be used as criteria for stopping execution of the algorithm. This approach may increase the clustering speed.

However, this approach may deteriorate efficiency of clustering since the document clustering in this approach is significantly influenced by a condition for stopping the execution of the algorithm.

There are other algorithms including a single link method and a group average method in which (n2) time is required for performing the algorithm. A complete link method requires (n3) time for performing the algorithm.

A linear time clustering algorithm for real-time document clustering includes k-means algorithm and a single path method. Typically, it is known that k-means algorithm has superior efficiency of search if a cluster is sphere-shaped on a vector plane. However, it is substantially impossible to always have a sphere-shaped cluster. Such a single path method is dependent on the order of documents used for clustering, and produces large clusters in general.

In a study related to the present invention, “fractionation” and “buckshot” are transformations of AHC method and k-mean algorithm, respectively. Fractionation has drawbacks in respect of “time”, similarly to AHC method, and buckshot may cause a problem when a user is interested in a small cluster which is not included in the document sample since the buckshot produces a start centroid by adopting AHC clustering to document sample.

As another document clustering method, there is an STC(suffix tree clustering) algorithm, in which clusters are produced based on the phrase shared by documents. A study has been made where document clustering is performed by applying STC algorithm to the summary of web documents, resulting in failure of obtaining satisfaction in terms of both time and accuracy of search, similarly to other trials.

In the present invention, Bayesian SOM is utilized for performing the search to relevant documents in accordance with semantic similarity of query words given by a user and utilizing real-time classification characteristics, merits of neural network. For the thus-clustered document, order of clusters is re-ranked through the computation of similarity using Kohonen centroid of document cluster. Here, computation of the information volume between query word given by a user and index word of document is performed in such a manner that an entropy value between index word of each document and query word and user profiles is obtained, based on the entropy information, and thus-obtained entropy value is used as an input value to clustering variable.

The entropy information for index word “d” of document can be expressed as the following formula(1).

$$H ( {P}_{d} ) = - {\sum }_{i = 1}^{n} {P}_{i} {log}_{2} {P}_{i} \qquad Formula ( 1 )$$

In general, entropy value is computed employing “2” as a base for the log function, like “log2”, which is applicable when the data to be computerized is binary data. In the present invention, natural log having “e” as a base of log function is used.

Statistical similarity between document cluster and query word given by a user can be explained as follows.

Clustering individuals aims to assist understanding of overall structure by grouping individuals according to similarity and recognizing characteristics of each group. “Recognizing characteristic of each group” as referred in the present invention, is computation of similarity between a collection of documents and query word. Utilizing thus-obtained similarity, the document collections with high similarity is ranked at high level.

Typically, there have been a lot of clustering methods for individuals, such as k-mean clustering method, a method by determination on the distance of statistical similarity and dissimilarity, and a method utilizing Kohonen self-organizing feature map, and the like.

In the present invention, characteristics of groups for clustering can be expressed in the number of relevant documents that a specific group includes to match the information request from the user. That is, document clustering performed in a system where document ranking is obtained by computing entropy value between keyword of each document and query word and user profiles, and grouping the documents by using the entropy value as a value for clustering variables, results in further increased user satisfaction than a document clustering system where each of a large collection of documents is individually ranked.

If N-number of documents computed for each of the p-number of cluster variables(entropy) results in a matrix of N X P, one row vector corresponding to the computed value for each document may be considered as a single point in p-dimensional space. Here, it would be highly meaningful, in terms of document clustering performed by query words given by a user, if one is provided with information regarding whether N-number of points are distributed throughout the p-dimensional space in a certain distribution, or clustered with an intimacy.

However, if the clustering variable is higher than three-dimensions, which is difficult to understand visually, N-numbers of points are organized and configured onto a two-dimensional plane so as to obtain grouping characteristics of N-numbers of points. For this purpose, the present invention employs an algorithm of self-organizing feature map.

The present invention has statistical similarity which can be explained as follows.

In principle of clustering, documents belonging to the same cluster have high similarity, while the documents belonging to other clusters have relative dissimilarity. Therefore, it is an object of the clustering to recognize overall structure for the entire documents by identifying, based on similarity(or dissimilarity), members of cluster, and defining the procedure of clustering, characteristics of clustering and relationship between identified clusters, under the condition where the number, content and configuration of clusters for each document are not defined in advance. As described above, the cluster analysis is an exploratory statistical method, in which natural cluster is searched and document summary is sought in accordance with similarity or dissimilarity between documents, without having any prior assumption for the number of clusters or structure of the cluster.

To group individual documents, a measure for clustering documents is needed. As a measurement, similarity and dissimilarity between documents is used. Here, if similarity between documents is employed as a measurement, documents having relatively higher similarity are classified into the same group. If dissimilarity is employed, documents having relatively lower dissimilarity are classified into the same group. The most fundamental method employing dissimilarity between two documents is to use distance between documents. To perform document clustering, a reference measure for measuring the degree of similarity or dissimilarity among the clustered documents is required.

In the present invention, similarity or dissimilarity can be summarized via a concept of statistical distance between the relevant documents. Assume that Xⱼₖ indicates entropy of k-th word of j-th document, and Xⱼ′=(Xⱼ₁, Xⱼ₂, . . . , Xⱼₚ) indicates j-th row vector for p-number of entropy values of document j. Then, all of the documents can be expressed in the matrix where dimension is N x p, i.e., X(_{Nxp}), as follows.

$${X}_{( N \times P )} = [ \begin{matrix}{X}_{11} {X}_{12} … {X}_{1 p} \\ {X}_{21} {X}_{22} … {X}_{2 p} \\ … \\ {X}_{N1} {XN}_{N2} … {X}_{N p}\end{matrix} ] = [ \begin{matrix}{X}_{1} \\ {X}_{2} \\ … \\ {X}_{N}\end{matrix} ] \qquad Formula ( 2 )$$

To measure dissimilarity between the two documents Xi′ and Xj′, distance between the two documents Xi′ and Xj′, dij=d(Xi,Xj) is calculated, and distance matrix D of N×N expressed in the following formula(3) is obtained for all of the documents.

$${D}_{( N \times N )} = [ \begin{matrix}{d}_{11} {d}_{12} … {d}_{1 j} … {d}_{1 N} \\ {d}_{21} {d}_{22} … {d}_{2 j} … {d}_{2 N} \\ … \\ {d}_{i1} {d}_{i2} … {d}_{ij} … {d}_{iN} \\ … \\ {d}_{N1} {d}_{N1} … {d}_{Nj} … {d}_{NN}\end{matrix} ] \qquad Formula ( 3 )$$

In formula(3), distance dij between the two documents i and j is a function for Xi and Xj, and should satisfy the following distance conditions.

(1) dᵢⱼ≧0; if i=j,dij=0

(2) dᵢⱼ=dⱼᵢ

(3)dᵢₖ+d_{jk≧dij}

A clustering algorithm according to the present invention uses a method where distance matrix D having a size of N×N where dij is used as an element is employed, and the documents having relatively short distance form the same cluster, to thereby allow variation within a cluster to be smaller than those between clusters. There exists a variety of approaches for measuring distance. The present invention employs Euclid's distance where m is 2 in Minkowski distance, as expressed in the following formula.

$${d}_{ij} = d ( {X}_{i} , {X}_{j} ) = {[ {\sum }_{k = 1}^{p} {\vert {X}_{ik} - {X}_{jk} \vert}^{m} ]}^{1 / m} \qquad Formula ( 4 )$$

Since the formula(4) is not provided with scale invariance, the reliability for clustering is low if the unit for each of the variables is different. To solve such problems, standardization for each of the clustering variables can be sought in order to basically eliminate the unit for measuring distance by dividing each of the variables by a standard deviation of the corresponding variable. However, since the variables employed for document clustering in the present invention use the clustering variable of the same unit, i.e., entropy, standardization for clustering variables is not considered. Similarity(Sij) between the two documents Xi and Xj can be proposed in a variety of methods, such as a method where the correlation coefficient between variables(Xᵢₖ, Xᵢⱼ)(k=1,2, . . . p) for the two documents is used, as the following formula(5).

$${S}_{ij} = \frac{{\sum }_{k = 1}^{p} ( {X}_{ik} - {\overline{X}}_{i} ) ( {X}_{jk} - {\overline{X}}_{j} )}{{\{ {\sum }_{k = 1}^{p} {( {X}_{ik} - {\overline{X}}_{i} )}^{2} {\sum }_{k = 1}^{p} {( {X}_{jk} - {\overline{X}}_{j} )}^{2} \}}^{2}} \\ {\overline{X}}_{i} = \frac{1}{p} {\sum }_{k = 1}^{p} {X}_{ik} , {\overline{X}}_{j} = \frac{1}{p} {\sum }_{k = 1}^{p} {X}_{jk} \qquad Formula ( 5 )$$

In the formula(5), the correlation coefficient is an intermediate angle between the two vectors(i.e., two documents Xi and Xj), say, cosine of θij, in p-dimensional space. Accordingly, as the intermediate angle becomes smaller, cos(θij)=sij becomes closer to 1. This means that the two documents are similar to each other. However, such a measurement for measuring similarity has shortcomings in that (\overline{X}₁) is not suitable for analyzing correlation, and the correlation coefficient measures only the linear relationship between the two variables.

As another measure for similarity, Sij=1/(1+dij) or Sij=constant−dij, can be considered from the distance dij which is a measure for dissimilarity between the two documents Xi and Xj. In general, Sij has the value between 0 and 1, and as Sij becomes closer to 1, similarity between the two documents becomes higher.

In the present invention, the distance between documents is computed and used as a relative measurement for document clustering.

A hierarchical clustering as used in the present invention can be explained as follows.

A hierarchical clustering utilizing distance matrix D having the size of N×N computed from N-number of documents, can be classified into two types; agglomerative method and divisive method. The agglomerative method produces clusters by placing all of the documents in each group and clustering documents having short distance. The divisive method places all documents into a single group and divides the document having long distance. In such a hierarchical clustering, a document belonging to a certain cluster may not be clustered into the same cluster again. In detail, the agglomerative method combines the two clusters having shortest distance into a single cluster, and allows the other (N-2)-number of documents to form a single cluster, respectively. Then, the two clusters having the shortest distance from among (N-1)-number of clusters, are grouped to produce (N-2)-number of clusters. Such procedures in which a pair of clusters are combined in each step, being based on the measure of distance, are continued to (N-1)-th step where N-number of documents are grouped into a single cluster.

To the contrary, the divisive method first divides N-number of documents into two clusters. Here, the number of methods of division is (2N−1−1). The result obtained from the hierarchical clustering can be simply expressed by a dendrogram in which the procedure of agglomerating or dividing clusters is represented onto a two-dimensional diagram. In other words, the dendrogram can be used for recognizing relationships between clusters agglomerated(or divided) in a specific step, and understanding structural relationship among the clusters in their entirety.

The agglomerating method can be divided into several types according to how the distance between clusters is defined. The aforementioned distance matrix is a distance between documents. Therefore, since two or more documents are included in a single cluster, there exists a necessity of re-defining distance between clusters.

When clusters having one or more documents are grouped, distance between clusters needs to be computed. The following are methods for such computation.

(1) single linkage method

The distance between the two clusters C1 and C2 is shortest from among the distance between certain two documents belonging to each of the clusters, and can be defined as d{(C₁)(C₂)}=min{d(x,y)|x εC₁,y εC₂}. Here, the single linkage method combines two clusters if a distance between two specific groups is shorter than that between other two groups.

(2) Complete Linkage Method

To the contrary, the distance between the two clusters C1 and C2 is theongest from among the distance between certain two documents belonging to each of the clusters, and can be defined as

Here, if dᵢⱼ<h, individuals i and j belong to the same cluster. (wherein, h is a certain level)

(3) Centroid Linkage Method

As a distance between the two clusters C1 and C2, the distance between centroids of the two clusters is used

$${\overline{X}}_{2} = {\sum }_{j = 1}^{{N}_{1}} {X}_{ij} / {N}_{1}$$

is the centroid of cluster Ci(i=1,2) having the size of Ni, and P is a dissimilarity measure which is equal to the square of Euclid's distance between the two clusters, the distance between the two clusters C1 and C2 can be defined as d(C₁, C₂)=P(\overline{X}₁, \overline{X}₂).

(4) Median Linkage Method

The centroid of a new cluster which is formed by combining two clusters C1 and C2, is a weight mean, (N₁ \overline{X}₁+N₂\overline{X}₂)/(N₁+N₂).Therefore, if the size of a cluster is significantly different, the centroid of the newly formed cluster is disposed to be extremely adjacent to a sample having a large size. Even worse, the centroid may be disposed within the sample. Accordingly, characteristics of the small-sized cluster may be substantially ignored.

To overcome such problems, the median linkage method uses (\overline{X}₁+\overline{X}₂)/2 as a centroid for a newly-formed cluster, regardless of the size of the cluster.

(5) Average Linkage Method

The distance between the two clusters C1 and C2 having size N1 and N2, respectively, is an average of a pair of N1N2 extracted from a document of each clusters, and can be defined as follows.

$$d \{ ( {C}_{1} ) ( {C}_{2} ) \} = ( 1 / {N}_{1} {N}_{2} ) {\sum }_{r} {\sum }_{s} {d}_{rs}$$

(6) Ward's Method

In this method, loss of information caused by clustering the documents into a single cluster in each step of cluster analysis is measured by squaring deviations between an average of the relevant cluster and documents.

In the present invention, hierarchical document clustering utilizing statistical similarity is as follows.

Clustering method includes k-nearest neighbor method, fuzzy method and the like. However, the present invention adopts a clustering method where documents are clustered by a statistical similarity, i.e., standardized distance between the two documents. In other words, a hierarchical document clustering where document cluster is formed through grouping documents having high statistical similarity, starting from each clusters made up of each documents expressed in terms of statistical similarity.

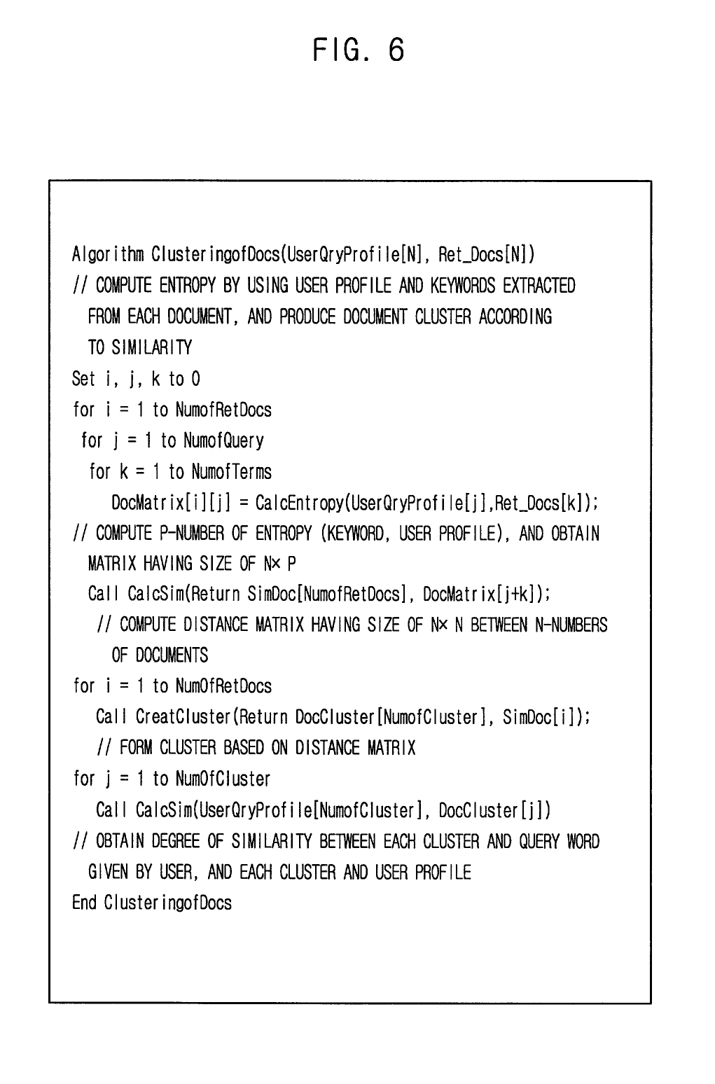

Clustering algorithm according to the present invention is the same as the algorithm illustrated in FIG. 6. Here, a variety of methods can be used in order to form cluster by using a distance matrix, and such a method can be used as it is, or can be combined for supplementation, if necessary.

(1) Disjoint Clustering

Each of the documents belongs to only one document cluster, from among a plurality of disjointed document clusters. This method is consistent with the method of the present invention, in which each of the documents belongs to only one cluster, and document clustering is performed in the order of high similarity to user profile through the order-ranking of clusters. Therefore, clustering method employed for the present invention is disjoint clustering method.

(2) Hierarchical Clustering

This type of clustering takes the format of a dendrogram where a cluster belongs to the other cluster, while preventing overlapping between clusters. In this type of clustering, document clusters which initially form different clusters at an early stage are merged into a single cluster due to mutual similarity through the successive clustering. In the present invention, such a hierarchical clustering method is employed.

(3) Overlapping Clustering

This type of clustering permits a single document to belong to two or more clusters at the same time. In other words, this is of a little flexible type which permits a single document to belong to a plurality of document clusters which are equal or have high similarity. However, this type is not consistent with a method of the present invention in which each documents are listed in order according to user profile.

(4) Fuzzy Clustering

In designating probability of each documents to belong to each document cluster any of the above-described disjoint, hierarchical, or overlapping clustering can be used. For this purpose, probability of each of the documents to belong the existing clusters and the clusters to be produced, is computed. In the present invention, such a probability is not used.

In the present invention, k-means clustering method, i.e., hierarchical document clustering, is employed while utilizing entropy data for document. Therefore, the overlapping clustering where one document belongs to two or more clusters, or a fuzzy clustering is not matched to a clustering method of the present invention.

Document clustering by utilizing SOM can be explained as follows.

(1) SOM and Competitive Learning

A Kohonen network self-organizing feature map mathematically models the intellectual activity of human, in which a variety of characteristics of input signals are expressed in a two-dimensional plane of the Kohonen output layer. Here, a semantic relationship can be found from a self-organizing function of neural network. As a result, a two-dimensional self-organizing feature map judges that patterns positioned near the plane have similar characteristics and clusters those patterns into the same cluster.

Inputs to neural networks for pattern classification can be sorted into two models that use successive value and binary value, respectively. Most neural networks require a learning rule which transmits a stimulation from an external source and changes the value of connection strength in accordance with the response from a model. Such neural networks can be classified into a supervised learning, in which the target value expected from input value is known, and output value is adjusted in accordance with the difference between the input value and the target value, and an unsupervised learning, in which the target value with respect to the input value is not known, and learning is performed by cooperation and competition of neighbor elements.

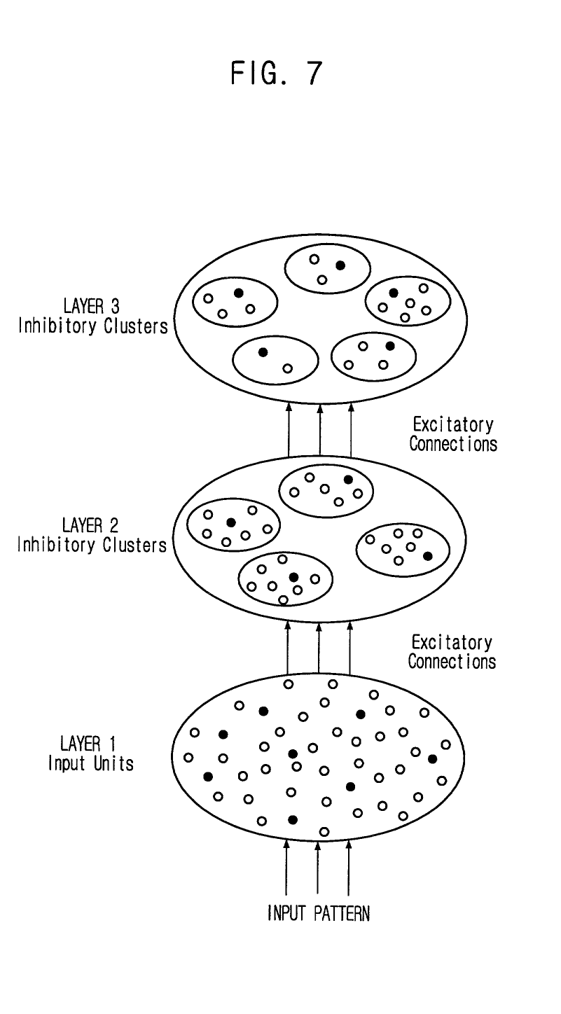

FIG. 7 illustrates the most generalized format of unsupervised learning, in which several layers constitute such a neutral network. Each layer is connected to the immediate upper layer through an excitatory connection, and each neuron receives inputs from all neurons of the lower layer. Neurons disposed in a layer are divided into several inhibitory layers, and all neurons disposed within the same cluster inhibit one another.

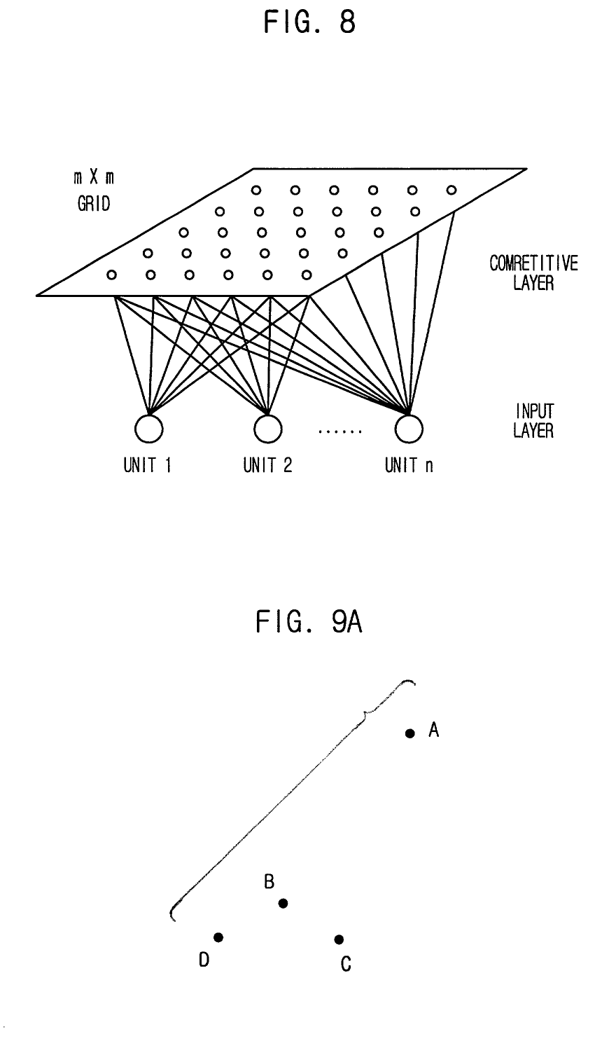

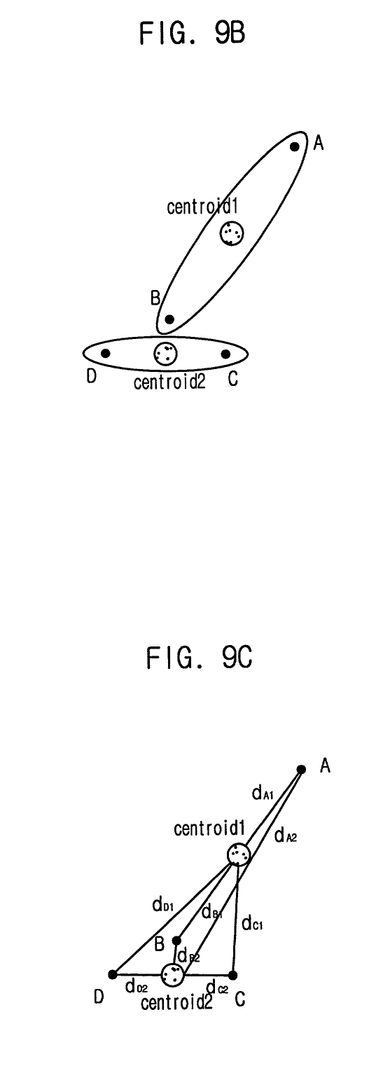

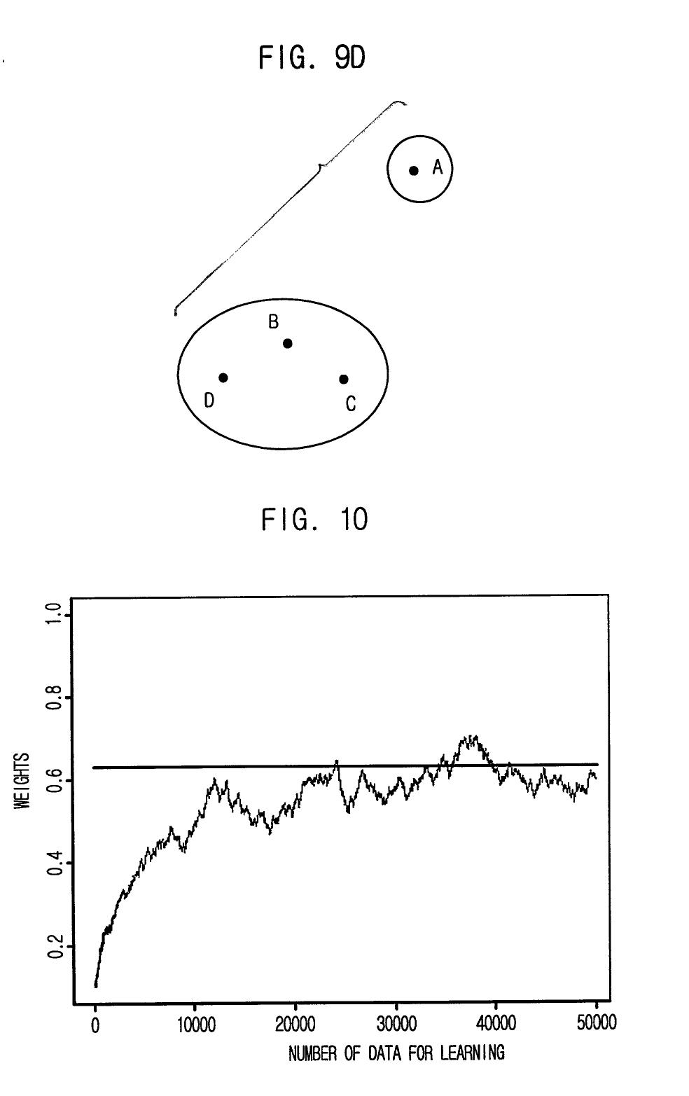

A Kohonen network that adopts competitive learning system is configured as two layers of input layer and output layer, as shown in FIG. 8, and two-dimensional feature map appears in the output layer.

Basically, a two-layer neural network is made up of an input layer having n-number of input nodes for expressing n-dimensional input data, and an output layer(Kohonen layer) having k-number of output nodes for expressing k-number of decision regions. Here, the output layer is also called a competitive layer, which is fully connected, in the form of a two-dimensional grid, to all neurons of the input layer.

SOM adopting an unsupervised learning system clusters n-dimensional input data transmitted from the input layer by self-learning, and maps the result into the two-dimensional grid of output layer.

(2) Weights Vector Updating Algorithm by Competitive Learning

Referring to FIG. 8, all input nodes are connected to all output nodes, and have connection weights wij. Here, wij are weights for connecting the input node i of the input layer and the output node j of the output layer. In SOM originally proposed by Kohonen, connection weights at an initial state are allocated with a random value. However, the present invention determines probability distribution for appropriately expressing data for learning and utilizes the value extracted from the distribution as initial weights rather than randomly allocating initial connection weights. The probability distribution utilized here is called Bayesian posterior distribution.

According to Bayesian's proposal, the posterior distribution can be obtained by multiplying prior distribution which results from prior experience or belief, and a likelihood function resulting from the data for learning. Here, the likelihood function is defined by joint distribution of given data for learning. However, such a Bayesian determination on the initial weight utilizing posterior distribution allows an early determination of the true value of connection weights, one of the network parameters, to thereby allow the neural network model to be rapidly converged, while preventing convergence into a local value.

After allocation of connection weights of the neural network, similarity to the input vector is measured. Similarity measurement can be performed in a variety of methods, and the present invention uses Euclid's distance by a standardized value. When Euclid's distance between N-dimensional input vector and k-number of weight vector is obtained, and j-th weight vector having the shortest Euclid's distance from the input vector is found, j-th output node becomes a winner with respect to input vectors.

The Kohonen network adopts a “winner takes it all” system, wherein only the winner neuron changes connection strength and produces output. If necessary, the winner neuron and the neighbor neurons cooperate to update connection strength. In such a model, learning is repeatedly performed in such a manner that the winner neuron and the neurons disposed within the neighboring radius adjust connection strength, to thereby gradually reduce the neighboring radius.

The following formulae(6) are for computation distance between the connection strength vector and the input vector. Here, neurons compete with one another in order to obtain the opportunity to learn, and the Kohonen network performs learning through such competition.

$${d}_{j} = {\sum }_{i = 0}^{N - 1} {x}_{i} ( t ) - {{w}_{ij} ( t )}^{2} \qquad Formula ( 6 )$$

The following formula(7) is for updating weight vector after the winner is selected. If the j-th output node becomes a winner, the connection weight vector for the j-th output node gradually moves toward to an input vector. This can be explained by a process of making the weight vector become similar to the input data vector. SOM prepares generalization through such a learning process.

w^{j} (t+1)=W^{J}(t)+α(t)[x(t)−w^{j}(t)] Formula(7)

In the present invention, only the weight value for the winner node is updated by the formula(7). Here, learning rate a(t) is a random value, or can be obtained from 0.1*(1−t/10⁴).

When the winner for each input is determined, the weight vector moves toward the input vector by the updated value of the weight vector. Such a movement has a non-uniform range of variation at an early stage, however, it is gradually stabilized to converge into a uniform weight vector value.

After learning is completed, each weight vector approximates to the centroid of each decision region, and allocates a newly-input document to the highest similarity class utilizing SOM structure where learning is completed. In other words, if the data similar to those used during the learning stage is input, the node with the highest similarity at the two-dimensional plane becomes the winner and is sorted into a class corresponding winner node. If a completely new data which may not be allocated to the existing class is input, a similar class may not be found at a map. Therefore, a new node is allocated so as to produce a completely new class.

Bayesian SOM and bootstrap algorithms as utilized throughout the present invention, can be explained as follows.

A document order-ranking method designed according to the present invention is for order-ranking clustered documents, rather than order-ranking individual documents. Here, clustering for each document is sought by Kohonen SOM where Bayesian's probability distribution is applied. In such cases, if data for learning is not sufficient, a statistical bootstrap algorithm is employed so as to ensure sufficient volume of data.

(1) K-means Method

K-means method is a basic technique for building a SOM model, i.e., Kohonen network, in which the relevant document is allocated to the nearest document cluster from among a plurality of document clusters disposed around the relevant document. Here, “nearest” indicates the case where the distance between the document and the centroid of each document cluster is shortest.

K-means method is performed in three-stages, as follows.

Stage 1: document in its entirety is divided into K-number of initial document clusters. Here, the initial K-number of document clusters is arbitrarily determined.

Stage 2: a new document is allocated to the document cluster having a centroid a distance from which each document is shortest. The centroid of document cluster which receives the newly allocated document changes to a new value.

Stage 3: stage 2 is repeated until re-allocation stops.

In stage 1, a seed point is used for dividing the document into K-number of initial document clusters. However, if the prior information for the seed point is known, an improved accuracy and speed for clustering can be obtained.

(2) Bootstrap Algorithm

The present invention adopts a Bayesian learning system as a document clustering method in order to obtain initial weight of SOM which is a representative neural network model of unsupervised learning proposed by Kohonen. Thus, initial weight for the Kohonen network can be obtained by Bayesian prior distribution.

When Bayesian prior distribution is used, learning time, i.e., the time period taken for clustering, can be reduced by utilizing weights that include a large volume of actual data. Such a method results in further correct clustering as compared with the clustering performed by Kohonen network where a simple random value is used as an initial weight.

Bayesian prior distribution can be obtained from data for learning.

However, if the volume of data for learning is small, accurate Bayesian prior distribution cannot be estimated. Therefore, if the volume of data for learning is not sufficient, a bootstrap algorithm is used as a statistical technique for ensuring volume of data sufficient for learning neural network. Bayesian prior distribution can be obtained from thus-ensured data for learning and network structure.

A Bootstrap algorithm is originally designed for statistical inference, and is a kind of re-sampling technique in which only the restricted amount of given data is utilized to estimate modulus of probability distribution without utilizing correct data for distribution. Such a bootstrap algorithm is performed mainly through a computer simulation.

In terms of statistics, bootstrap technique is for obtaining characteristics of data distribution by utilizing only data. In other words, distribution of population to which data for learning belongs can be estimated from only data for learning, and the probability distribution can be used for obtaining initial connection weights of Kohonen neural network through Bayesian method.

Typically, a large volume of data is required for finding characteristics of data. Bootstrap technique proposes an approach to produce a large volume of data required for experiment. Such a bootstrap allows supplementation to the volume of data for learning when the data for learning in neural network is not sufficient.

When initial weights for the network is determined in the document clustering utilizing Bayesian SOM of the present invention, it is difficult to estimate an appropriate estimation for Bayesian prior distribution if the volume of data for learning is not sufficient. To ensure sufficient volume of data for learning, sampling with replacement is performed through a simple random sampling from the existing data group. With the method, the volume of data sufficient for estimating prior distribution can be ensured. In detail, if n-number of data is given as d1, d2, . . . , dn for example, any data is randomly sampled from n-number of data if data for learning is insufficient. Such a sampling method is called a simple random sampling, and thus-sampled document utilizes a method of sampling with replacement where the document returns to the original n-number of document collections. Subsequently, another document is randomly sampled from the document collection, and returns to the document collection in a similar manner. By repeating such procedures, a sufficient volume of data required for neural network can be ensured.

In general, connection weight by final learning in neural network learning, is determined as the value of the time when there is no further change of connection weight in a certain range. However, thus-determined weight value has problems in that the weight value may converge into a local convergence value rather than the true value. In such cases, the determined weight value is valid within a network model with given learning data. However, such a weight value may become invalid value when it is out of the range of data for learning.

To avoid such an error, bootstrap algorithm is employed for ensuring sufficient volume of data for learning. With the sufficient volume of data, learning which allows convergence to the true value of the network modulus can be performed.

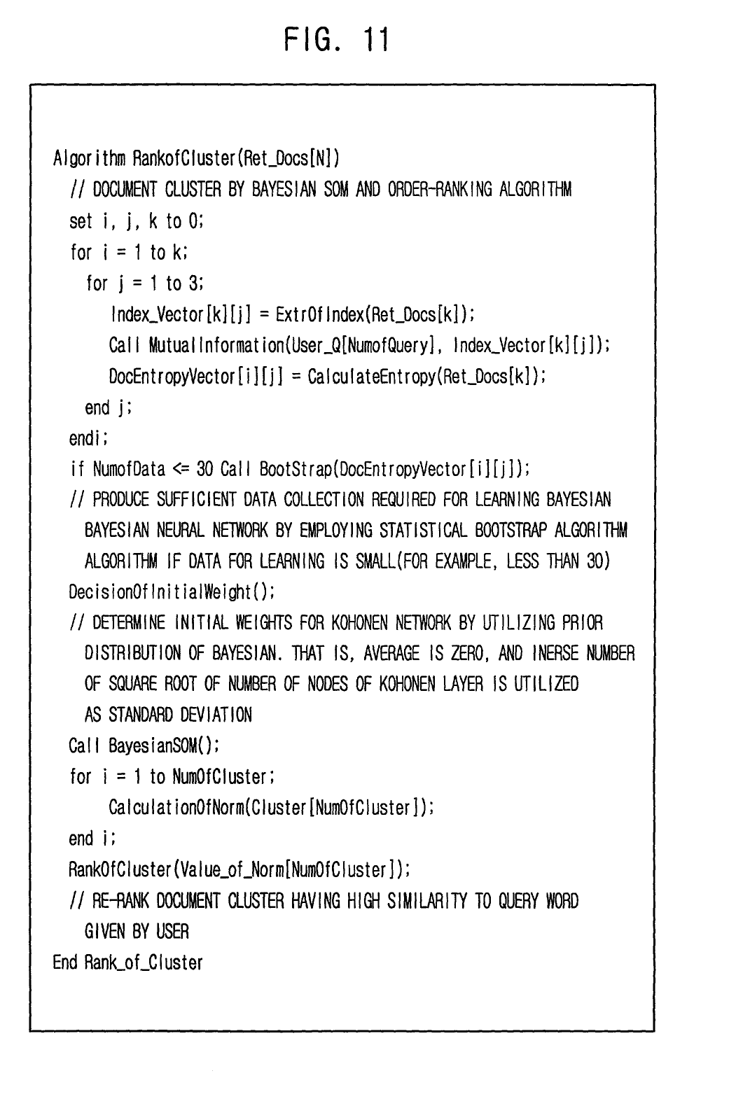

FIG. 10 is a graphical representation illustrating the relationship of convergence to true value between one of plural connection weights and the number of data for learning in a common multi-layer perception model.

In the graph, the final connection weight approximates to the true value of the model, i.e., 0.63, in accordance with the number of data for learning. In a section where the number of data is less than 10,000, the finally determined weight value converges into the local convergence value rather than approximating the true value of the connection weight value. As is seen in the graph, the weight value approximates the true value of the connection weight when the number of data for learning is 40,000 or higher. Therefore, it is important to ensure a sufficient volume of data for learning which can determine an accurate weight value of a given model in neural network learning. Sometimes, it is not easy to ensure a sufficient volume of data. In such cases, bootstrap technique of sampling with replacement through simple random sampling ensures a large volume of data for learning, convergence to the true value of the model through sufficient learning can be obtained.

Recently, there have been many advances in the study of a variety of document clustering techniques. However, a study of the combination of statistical distribution theory with a neural network is relatively poor. Understandably, the present invention proposes an algorithm which has enhancement in terms of accuracy and speed utilizing statistical distribution theory.

FIG. 11 shows a document clustering algorithm utilizing Bayesian SOM where statistical probability distribution theory is combined with a neural network theory.

As described above, a method of order-ranking document clusters using entropy data and Bayesian self-organizing feature maps(SOM), according to the present invention, is advantageous in that an accuracy of information retrieval is improved by adopting Bayesian SOM for performing real-time document clustering for relevant documents in accordance with a degree of semantic similarity between entropy data extracted by using entropy value and user profiles and query words given by a user, wherein the Bayesian SOM is a combination of Bayesian statistical technique and Kohonen network that is an unsupervised learning. The present invention allows savings of search time and improved efficiency of information search by searching only a document cluster related to the keyword of information request from a user, rather than searching all documents in their entirety.

In addition, the present invention provides a real-time document cluster algorithm utilizing a self-organizing function from Bayesian SOM and entropy data for query words given by a user and an index word of each of the documents expressed in an existing vector space model, so as to perform document clustering in accordance with semantic information to the documents listed as a result of the search in response to a given query in a Korean language web information retrieval system. The present invention is further advantageous in that, if the number of documents to be clustered is less than a predetermined number(30, for example), which may cause difficulty in obtaining a statistical characteristic, the number of documents is then increased up to a predetermined number(50, for example) using a bootstrap algorithm so as to seek document clustering with an accuracy, a degree of similarity for thus-generated cluster is obtained by using Kohonen centroid value of each of the document cluster groups so as to rank in higher order the document which has the highest semantic similarity to the query word given by a user, and the order of cluster is ranked in accordance with the value of similarity, so as to thereby improve accuracy of search in the information retrieval system.

The many features and advantages of the present invention are apparent in the detailed specification, and thus, it is intended by the appended claims to cover all such features and advantages which fall within the true spirit and scope of the invention. Further, since numerous modifications and changes will readily occur to those skilled in the art, it is not desired to limit the invention to the exact construction and operation illustrated and described, accordingly, all suitable modifications and equivalents may be resorted to, falling within the scope and spirit of the invention.

What is claimed is:

1. A method of order-ranking document clusters in a plurality of web documents having keywords using entropy data and Bayesian SOM, said method comprising:
a first step of recording a query word by a user;
a second step of designing a user profile made up of keywords used for most recent search and frequencies of the keywords, so as to reflect user's preference;
a third step of calculating an entropy value between keywords of each web document and said query word and user profile;
a fourth step of collecting data and judging whether data for learning Kohonen neural network is sufficient or not;
a fifth step of ensuring a number of documents using a bootstrap algorithm statistical technique, if it is determined in said fourth step that said data for learning Kohonen neural network is not sufficient;
a sixth step of determining prior information to be used as an initial value for each of a network parameter through Bayesian learning, and determining an initial connection weight value of Bayesian SOM neural network model where said Kohonen neural network and Bayesian learning are coupled to one another; and
a seventh step of performing real-time document clustering for relevant documents of said plurality of web documents using said entropy value calculated in said third step and Bayesian SOM neural network model.

2. A method according to claim 1, wherein said seventh step of performing document clustering further comprises the step of calculating entropy value between keywords of each web document and query word given by a user and user profile, and determining a clustering variable.

3. A method according to claim 1, wherein said prior information determined in advance in said sixth step of determination is in the form of a probability distribution, and said network parameter has a Gaussian distribution.

4. A method according to claim 1, wherein said number of documents to be ensured by said bootstrap algorithm is fifty.

5. A method according to claim 1, wherein said document clustering is performed by an average clustering method.

6. A method according to claim 1, wherein said document clustering is performed by an approach utilizing a distance of statistical similarity or dissimilarity.

7. A method according to claim 1, wherein said Bayesian SOM is built by K-means method for allocating a relevant document to a nearest document cluster from among a plurality of document clusters disposed around a document.

8. A method according to claim 7, wherein said K-means method comprises:
a first step of dividing the entire document into K-number of initial document clusters;
a second step of allocating a new document into a document cluster having a centroid which allows shortest distance from each document; and
a third step of repeating said second step of allocating until re-allocation stops,
wherein said K-number of initial document clusters is determined randomly in said step of dividing the entire document,
said centroid of said document cluster receiving said new document has a new value changed from a previous value in said step of allocating a new document, and said repeating step utilizes a seed point if said entire document is divided into random K-number of initial clusters in said step of dividing entire document.
